(19) United States
(12) Patent Application Publication
(10) Pub. No.: US 2013/0090772 A1
(43) Pub. Date: Apr. 11, 2013

(54) METHOD AND SYSTEM FOR ORIENTING AN IRRIGATION SYSTEM TO MINIMIZE WIND DAMAGE

(71) Applicant: Jochen Pfrenger, Omaha, NE (US)

(72) Inventor: Jochen Pfrenger, Omaha, NE (US)

(73) Assignee: Lindsay Corporation, Omaha, NE (US)

(21) Appl. No.: 13/267,206

(22) Filed: Oct. 6, 2011

(51) Int. Cl. G05D 3/12; G05D 7/06

(52) U.S. Cl. 700/284; 700/302

(57) ABSTRACT

An irrigation system comprises a central pivot; a main section pivotally connected to the central pivot; and a control system for positioning the main section to minimize wind damage. The control system comprises a location-determining component for determining a current position or bearing of the main section; a wind sensor for determining wind direction; and a computing device coupled with the wind sensor and the location-determining component for determining an optimal orientation of the main section based on an output of the wind sensor and the current position or bearing of the main section and for directing the motors to drive the wheels of the mobile towers to orient the main section in the optimal orientation.

### BACKGROUND OF THE INVENTION

1. Field of the Invention

The present invention relates to agricultural irrigation systems. More particularly, the invention relates to a method and system for orienting an irrigation system to minimize wind damage to the system.

2. Background

Agricultural irrigation systems such as central pivot irrigation machines are commonly used to irrigate crops. A central pivot irrigation machine typically includes, among other things, a central pivot communicating with a pressurized water supply and a series of mobile support towers connected to the central pivot and to one another by truss-type framework sections. The mobile support towers are supported on wheels that are driven by a motor on each tower. A water distribution conduit is supported by the framework sections and a number of sprinkler heads, spray guns, drop nozzles, or other fluid-emitting devices are spaced along the length of the conduit.

Central pivot irrigation systems and other irrigation machines are susceptible to wind damage because of their length and relatively high center of gravity. It is not uncommon for irrigation systems to tip over when exposed to high winds and to become damaged without tipping over when exposed to lesser winds.

### SUMMARY

Applicant has discovered that wind damage to an irrigation system can be greatly reduced and even eliminated entirely when the irrigation system is positioned so as to reduce its profile facing the wind. An embodiment of the invention takes advantage of this discovery by providing an irrigation system comprising a central pivot; a main section pivotally connected to the central pivot; and a control system for positioning the main section to minimize wind damage.

The main section may comprise a series of mobile towers connected to the central pivot and to one another by support structure. Each mobile tower has wheels and a motor for driving at least one of the wheels.

An embodiment of the control system comprises a location-determining component for determining a current position or bearing of the main section; a wind sensor for determining wind direction; and a computing device coupled with the wind sensor and the location-determining component. The computing device is configured for determining an optimal orientation of the main section based on an output of the wind sensor and for operating the wheels of the mobile towers to position the main section in the optimal orientation. Generally, the optimal orientation of the main section is parallel to a predominant direction of the wind.

The computing device may also be configured for determining an optimal orientation of the main section based on both an output of the wind sensor and the current position or bearing of the main section. For example, if the winds are predominantly from due west, the optimal orientation of the main section could be pointing due west or due east, as either would align the irrigation system with the wind. If the irrigation system is currently pointing to the southwest, it can be oriented due west more quickly than due east, so the computing device directs the motors to move the main section to point due west to place the irrigation in a wind-safe orientation as quickly as possible.

The computing device may also take into account the wind speed when determining whether to position the main section. For example, the computing device may only move the main section if the wind sensor measures wind speeds greater than some threshold (e.g. 20 mph).

Another embodiment of the control system comprises a location-determining component for determining a current position or bearing of the main section; a receiver for receiving wind data from a weather source; and a computing device coupled with the receiver and the location-determining component. The computing device operates in the same manner as described above except that it receives wind data from an external source rather than a resident wind sensor.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures. For example, the principles of the present invention are not limited to central pivot irrigation systems, but may be implemented in other types of irrigation systems including linear move irrigation systems.

### BRIEF DESCRIPTION OF THE DRAWING FIGURES

Embodiments of the present invention are described in detail below with reference to the attached drawing figures, wherein:

FIG. 1 is a perspective view of a central pivot irrigation system constructed in accordance with embodiments of the invention.

FIG. 2 is a plan view showing an angular position or bearing of the irrigation system relative to North and a predominant wind direction.

FIG. 3 is a plan view showing another angular position or bearing of the irrigation system relative to North and a predominant wind direction.

FIG. 4 is a plan view showing another angular position or bearing of the irrigation system relative to North and a predominant wind direction.

FIG. 5 is a block diagram of a control system constructed in accordance with an embodiment of the invention.

FIG. 6 is a block diagram of another embodiment of the control system.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

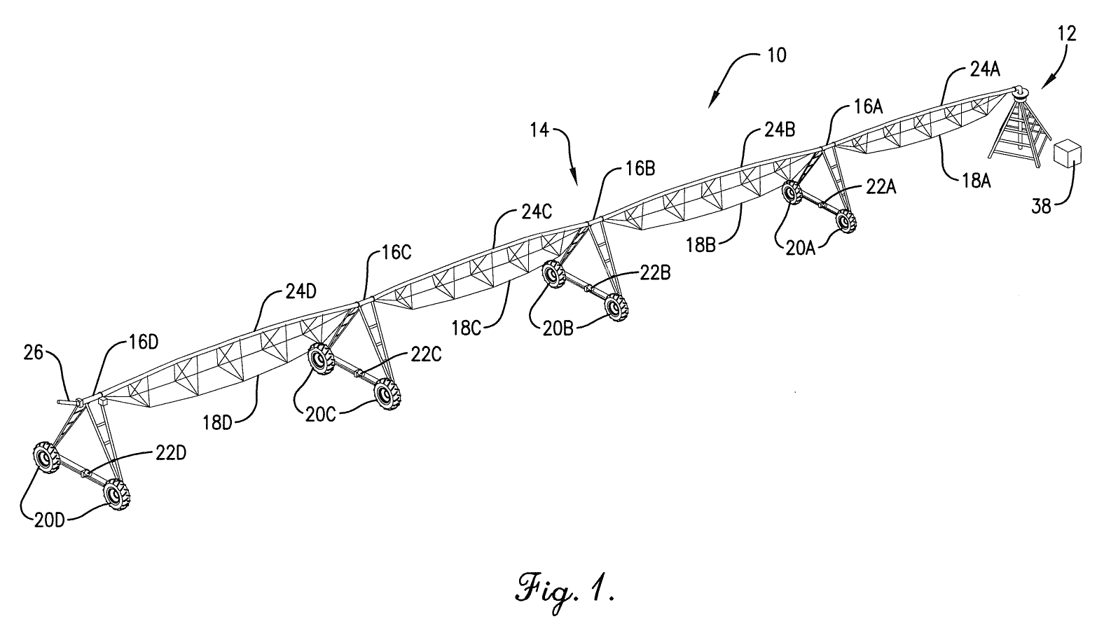

Turning now to the drawing figures, and initially FIG. 1, an exemplary irrigation system 10 on which principles of the present invention may be implemented is illustrated. An embodiment of the irrigation system 10 is a central pivot irrigation system and broadly comprises a fixed central pivot 12 and a main section 14 pivotally connected to the central pivot. The irrigation system 10 may also comprise an extension arm (also commonly referred to as a “swing arm” or “corner arm”) pivotally connected to the free end of the main section.

The fixed central pivot 12 may be a tower or any other support structure about which the main section 14 may pivot. The central pivot has access to a well, water tank, or other source of water and may also be coupled with a tank or other source of agricultural products to inject fertilizers, pesticides and/or other chemicals into the water for application during irrigation.

The main section 14 may comprise any number of mobile support towers 16A-D, the outermost 16D of which is referred to herein as an end tower. The support towers are connected to the fixed central pivot 12 and to one another by truss sections 18A-D or other supports to form a number of spans.

The mobile towers have wheels 20A-D, at least one of which is driven by suitable drive motors 22A-D. Each motor 22A-D turns at least one of its wheels 22A-D through a drive shaft to move its mobile tower and thus the main section in a circle about the central pivot to irrigate a field. The operation of the motors is controlled by methods readily known in the art.

Although not required, some or all of the towers 16A-D may be equipped with steerable wheels pivoted about upright axes by suitable steering motors so that the towers can follow a predetermined track. U.S. Pat. No. 4,508,269 in the name of Davis et al. is hereby incorporated by reference in its entirety into the present specification for a disclosure of ground drive motors and steering motors associated with an irrigation machine. As is also well known, the drive motors for the towers are controlled by a suitable safety system such that they may be slowed or completely shut down in the event of the detection of an adverse circumstance, all of which is disclosed, for example, in U.S. Pat. No. 6,042,031 to Christensen, et al. incorporated herein by reference in its entirety.

Each of the truss sections 18A-D carries or otherwise supports a conduit section 24A-D or other fluid distribution mechanism that is connected in fluid communication with all other conduit sections. A plurality of sprinkler heads, spray guns, drop nozzles, or other fluid-emitting devices are spaced along the conduit sections 24A-D to apply water and/or other fluids to land underneath the irrigation system.

The irrigation system may also include an optional extension arm (not shown) pivotally connected to the end tower and may be supported by a swing tower with steerable wheels driven by a motor. The extension arm may be joined to the end tower by an articulating pivot joint. The extension arm is folded in relative to the end tower when it is not irrigating a corner of a field and may be pivoted outwardly away from the end tower while irrigating the corners of a field.

The irrigation system 10 may also include one or more high pressure sprayers or end guns 26 mounted to the end tower 16D or to the end of the extension arm. The end guns are activated at the corners of a field or other designated areas to increase the amount of land that can be irrigated.

The illustrated irrigation system 10 has four mobile support towers 16A-D; however, it may comprise any number of mobile support towers, truss sections, wheels, and drive motors without departing from the scope of the present invention.

The irrigation system 10 also includes a main control system for controlling movement of the mobile towers 16A-D and operation of the fluid-emitting devices in accordance with an irrigation program. The main control system may include a processor or other computing device with inputs that receive positional information from one or more GPS receivers mounted to the end tower or elsewhere. The processor may alternatively receive position information from angle encoders mounted between the central pivot and a first span of the main section. The processor may also include outputs connected to relay-controlled valves connected to the water-emitting devices and to relays connected to the electric motors 22A-D connected to the drive wheels of the mobile towers.

In accordance with aspects of the present invention, the irrigation system 10 also includes a control system 28 for controlling the positioning of the main section 14 to minimize wind damage to the irrigation system 10. The control system 28 can be implemented with hardware, software, firmware, or a combination thereof. One embodiment of the control system 28 is illustrated in FIG. 5 and comprises a computing device 30, memory 32, a location-determining component 34, and a wind sensor 36. Some or all of the functionality of the control system 28 may be performed by the main control system or vice versa. In other words, the irrigation system 10 may include a separate main control system and control system 28 or a single control system that integrates some or all of the functions of the main control system and control system 28.

The computing device 30 receives inputs from other components of the control system and determines optimal positions of the main section 14 to minimize wind damage as explained in more detail below. The computing device 36 may comprise or include any number or combination of processors, controllers, ASICs, or other control circuitry. As mentioned above, the computing device and other components of the control system may be part of the main control system so that a separate dedicated control system is not required.

A computer program that may be implemented by the computing device 36 may perform some of the control functions described herein. The computer program preferably comprises an ordered listing of executable instructions for implementing logical functions in the computing device. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The memory 32 may be any electronic memory that can be accessed by the computing device 30 and operable for storing instructions or data. The memory 32 may be integral with the computing device 30 or may be external memory accessible by the computing device. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the computing device or may communicate over a bus or other mechanism that facilitates direct or indirect communication. The memory may optionally be structured with a file system to provide organized access to data existing thereon.

In accordance with one important aspect of the invention, the memory 32 or other memory may store data that can be used to position the main section independent of current wind speeds. Those skilled in the art will appreciate that many areas experience winds that frequently blow from a single general direction because of surrounding terrain, nearby bodies of water, etc. Thus, the memory may store data representative of prevailing winds in the region in which the irrigation system is used and desired angles or orientations of the main section for these prevailing winds. Generally, the desired positions and/or angles of the irrigation system are those that orient the main section parallel to the prevailing winds. For example, if the irrigation system is used in an area with westerly prevailing winds, the memory may store data representative of these prevailing wind directions and data representative of orientations of the irrigation system that are parallel to these prevailing winds. The stored data may also indicate the prevailing wind directions for different dates and times. As described in more detail below, the computing device 30 may consider the stored prevailing wind data along with measured or received wind data to position the main section so as to minimize wind damage.

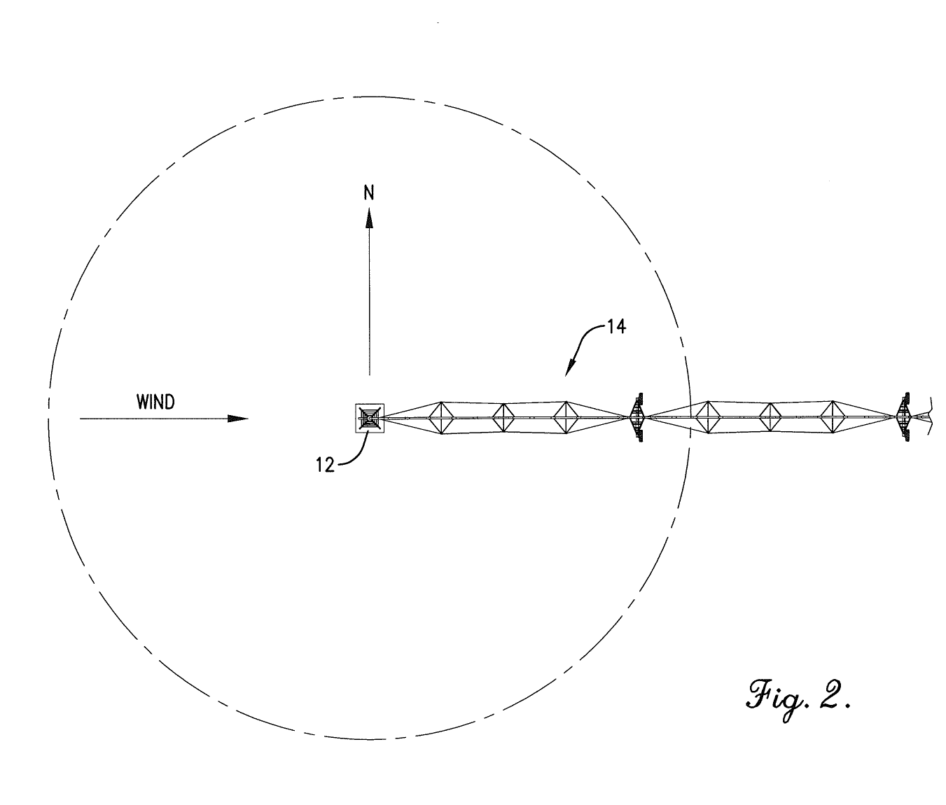

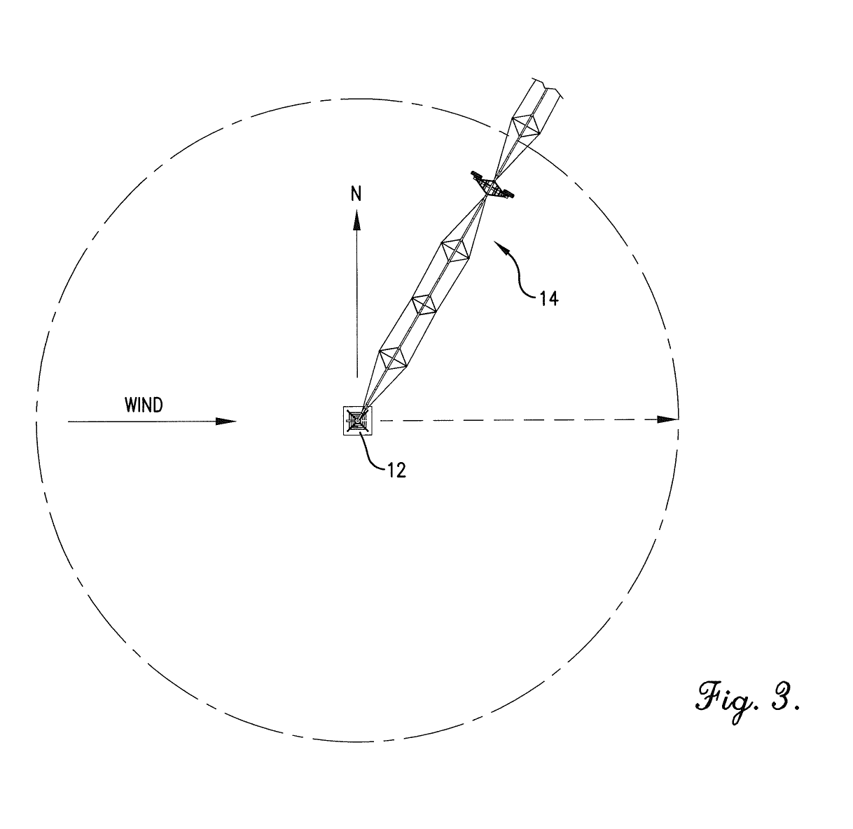

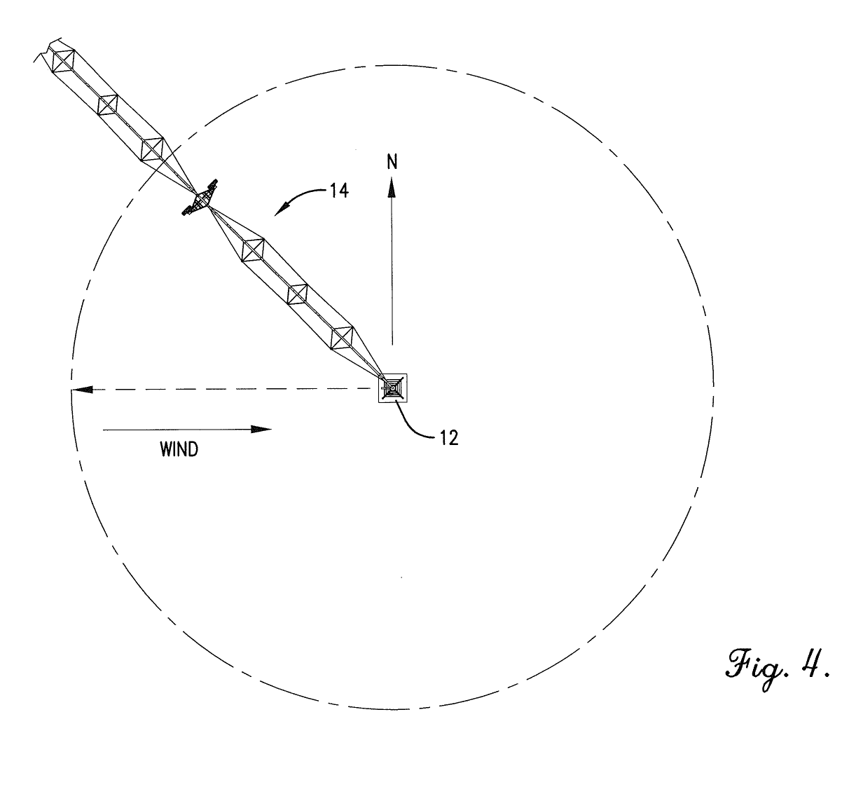

The location-determining component 34 determines, in a substantially conventional manner, location or orientation information for the main section 14. In one embodiment, the location or orientation information is determined or expressed as a bearing or angular displacement from a pre-determined line of reference such as North. For example, referring to FIG. 2, the main section's position may be determined or expressed as being 90° from North. Similarly, referring to FIG. 3, the main section's position may be determined or expressed as being 30° from North. Finally, referring to FIG. 4, the main section's position may be determined or expressed as being 225° from North.

The location-determining component 34 may be any device capable of determining the main section's position or orientation. The location-determining component may be, for example, an angle encoder positioned between the fixed central pivot 12 and the main section 14 for sensing an angle between a line extending through the length of the main section and an axis line such as North. In some embodiments, the angle encoder is incorporated in an existing articulating joint positioned between the central pivot 12 and the first span of the main section so that the control system 28 does not require its own dedicated angle encoder.

The location-determining component 34 may also be a global navigation satellite system (GNSS) receiver such as a GPS receiver, Glonass receiver, Galileo receiver, or Compass system receiver attached to or near the end tower 16D and operable to receive navigational signals from satellites to calculate a position of the end tower as a function of the signals. The computing device 30 then calculates an angle or bearing of the main section based on the position of the end tower and the fixed and known position of the central pivot 12. The GNSS receiver may include one or more processors, controllers, or other computing devices and memory for storing information accessed and/or generated by the processors or other computing devices. In some embodiments, the GNSS receiver is incorporated in the main control system so that the control system 28 does not require its own dedicated GNSS receiver. The GNSS receiver may be coupled with a GNSS patch antenna, helical antenna, or any other type of antenna mounted on or near the end tower.

The location-determining component 34 may also be any other receiving device capable of receiving location information from at least three transmitting locations and performing basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit.

The wind sensor 36 may be any device that can sense wind speed and direction. For example, the wind sensor may be an analog or digital anemometer with wind direction sensing capability. The wind sensor may be mounted to the irrigation system 10 or may be mounted to a nearby pole or building. The wind sensor may be wired to the computing device or may communicate with it wirelessly.

The control system 28 may also include a display, inputs for receiving programs and data from external devices, a cellular or other radio transceiver for wirelessly receiving and transmitting data from and to remote devices, and/or other components.

Some or all of the components of the control system 28 may be enclosed in or supported on a weatherproof housing 38 for protection from moisture, vibration, and impact. The housing 38 may be positioned anywhere on or near the central pivot 12 as illustrated in FIG. 1 and may be constructed from a suitable vibration- and impact-resistant material such as, for example, plastic, nylon, aluminum, or any combination thereof and may include one or more appropriate gaskets or seals to make it substantially waterproof or resistant.

The above-described components of the control system 28 need not be physically connected to one another since wireless communication among the various depicted components is permissible and intended to fall within the scope of the present invention.

In operation, the control system 28 monitors and controls the position and/or angle of the main section 14 to minimize wind damage to the irrigation system 10. In one embodiment, the computing device 30 accesses the memory and determines the direction of prevailing winds for the current date and time. The computing device may determine the current date and time from an internal or external clock or other timing device. The computing device 30 then determines the main section's current position or orientation from the location-determining component 34, determines the desired position or orientation of the main section, and directs the motors 22A-D to move the main section from its current position to the desired position. This allows the control system 28 to pre-position the irrigation system to point toward or away from the prevailing winds even when the prevailing winds are unlikely to cause wind damage under the theory that stronger, potentially damaging winds will come from the same direction.

In another embodiment, the computing device 30 receives wind speed and direction data from the wind sensor 36 and determines if the wind is strong enough to be a risk to the irrigation system. For example, the computing device may determine if the current wind speed is above a threshold wind speed. The threshold wind speed may be selected by an operator or owner of the irrigation system and be based on the type, size, and weight of the irrigation system. For example, for a relatively large and heavy irrigation system, the threshold wind speed may be 40 mph, but for a smaller and lighter irrigation system, the threshold wind speed may be 30 mph. If the current wind speed is greater than the threshold wind speed, the computing device 30 analyzes the direction of the wind to determine the desired position or angular orientation of the main section. The computing device 30 then determines the main section's current position or orientation, compares it to the desired position, and directs the motors 22A-D to move the main section from its current position to the desired position. As mentioned above, the desired angular orientation of the main section 14 is that which orients it generally parallel with a predominate direction of the wind.

In another embodiment, the computing device may consider the time duration of winds to determine if the irrigation system should be moved. For example, the computing device may only move the irrigation system if sustained wind speeds are above a selected threshold for a particular time period.

In yet another embodiment, the computing device may consider trends in the wind speed when determining whether to move the irrigation system. For example, if the wind speeds are rapidly increasing, the computing device may re-position the irrigation system even if the wind speed is not yet above a threshold amount.

In yet another embodiment, the computing device 30 also considers which direction to move the main section when positioning or pre-positioning it to minimize wind damage. Because the spans of the irrigation system 10 are generally aligned in a straight line, the main section 14 has approximately the same wind resistance whether it is facing the wind or facing away from the wind as depicted in FIG. 2. The computing device 30 thus compares the main section's current position or angle to the desired position or angle to determine the fastest route to the desired position and drives the drive wheels in the appropriate direction until the main section's actual position or angle match the desired position or angle. For example, if the irrigation system 10 is currently oriented as depicted in FIG. 3 and the winds are predominately from the west as shown, the computing device 30 determines that the main section 14 should be moved so that it points to the east as depicted by the dashed lines because it can be moved to this orientation more quickly than to an orientation pointing west. Conversely, if the irrigation system 10 is oriented as depicted in FIG. 4 and the winds are predominately from the west, the computing device 30 determines that the main section 14 should be moved so that it points to the west as depicted by the dashed lines because it can be moved to this orientation more quickly than it can be moved to point east.

The control system 28 may perform some or all of the above-described steps nearly continuously so that the main section 14 precisely aligns itself with the wind in real-time or may perform the steps periodically (e.g. every 5 minutes) so as to avoid more frequent movement of the irrigation system.

In yet another embodiment, the control device 28 may completely shut down the irrigation system 10 and all its active components whenever the wind sensor determines that the wind is blowing above a maximum threshold wind speed such as 60 mph. This may reduce damage in circumstances where the wind is blowing so strongly that the main section cannot be safely moved regardless of its current position.

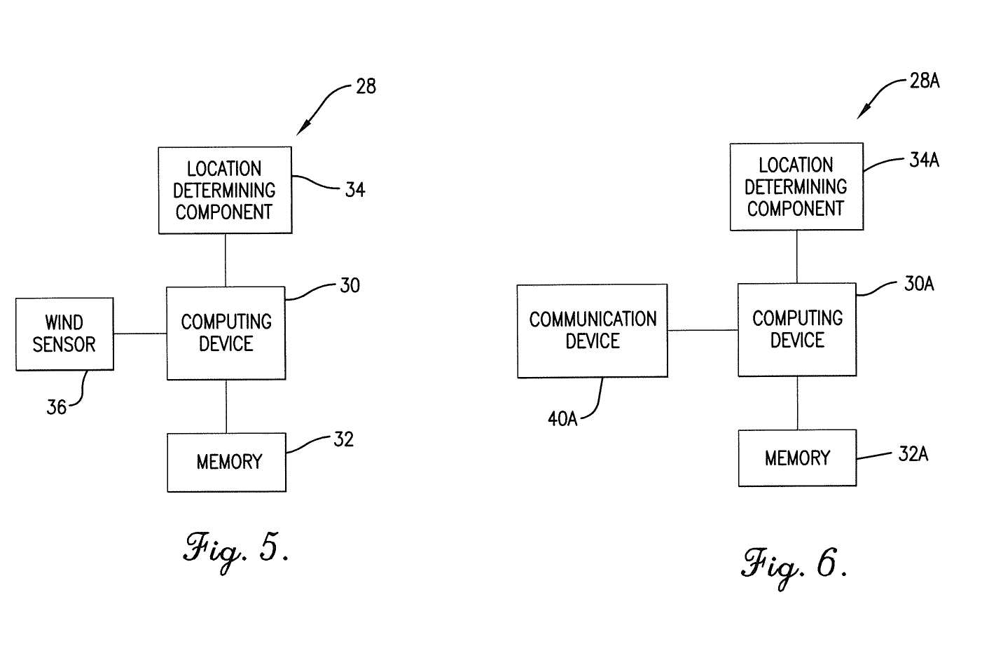

A control system 28A constructed in accordance with another embodiment of the invention is illustrated in FIG. 6 and broadly comprises a computing device 30A, memory 32A, a location-determining component 34A, and a communications device 40A. The computing device 30A, memory 32A and location-determining component 34A are similar to the like-numbered components described above and are therefore not described again. The communications device 40A may be any device operable to receive wind speed and direction data from an external source. For example, the communications device 40A may be a radio receiver operable to receive weather data from a weather source.

As with the embodiment of the control system 28 described above, the control system 28A monitors and controls the position and/or angle of the main section 14 to minimize wind damage. The only difference in the operation of the control system 28A is that it receives wind data from the communication device 40A rather than a wind sensor or other resident sensor. The wind data may include current actual wind speeds, expected future wind speeds and directions, or other wind data.

One or both embodiments of the control system 28, 28A may also comprise a tilt sensor, level sensor, motion sensor or other similar device operable for sensing when the main section 14 is tilting or otherwise moving when it is supposed to be stationary. Such a sensor could be used with or instead of the wind sensor 36 as an input to the computing device 30, 30A when positioning the main section. For example, the computing device could move the main section whenever this sensor detects unwanted movement of the main section in an attempt to re-position the main section to a more stable position.

Although the invention has been described with reference to the embodiments illustrated in the attached drawing figures, it is noted that equivalents may be employed and substitutions made herein without departing from the scope of the invention as recited in the claims. For example, the principles of the present invention are not limited to the illustrated central pivot irrigation systems but may be implemented in any type of irrigation system including linear move irrigation systems.

Having thus described the preferred embodiment of the invention, what is claimed as new and desired to be protected by Letters Patent includes the following:

1. An irrigation system comprising:
a central pivot;
a main section pivotally connected to the central pivot; and
a control system for positioning the main section to minimize wind damage.

2. The irrigation system as set forth in claim 1, wherein the main section comprises:
a series of mobile towers connected to the central pivot and to one another by support structure, each mobile tower having wheels and a motor for driving at least one of the wheels;
a water distribution conduit supported by the support structure; and
a number of fluid-emitting devices connected to the water distribution conduit.

3. The irrigation system as set forth in claim 2, wherein the control system comprises:
a wind sensor for determining a wind direction; and
a computing device coupled with the wind sensor for determining an optimal orientation of the main section based on the wind direction and for directing the motors to drive the wheels of the mobile towers to orient the main section in the optimal orientation.

4. The irrigation system as set forth in claim 2, wherein the control system comprises:
a location-determining component for determining a current position or bearing of the main section;
a wind sensor for determining wind direction; and
a computing device coupled with the wind sensor and the location-determining component for determining an optimal orientation of the main section based on the wind direction and the current position or bearing of the main section and for directing the motors to drive the wheels of the mobile towers to orient the main section in the optimal orientation.

5. The irrigation system as set forth in claim 2, wherein the control system comprises:
a location-determining component for determining a current position or bearing of the main section;
a wind sensor for determining wind direction and speed; and
a computing device coupled with the wind sensor and the location-determining component for determining an optimal orientation of the main section based on the wind speed, the wind direction, and the current position or bearing of the main section and for directing the motors to drive the wheels of the mobile towers to orient the main section in the optimal orientation.

6. The irrigation system as set forth in claim 2, wherein the control system comprises:
a receiver for receiving wind data from a weather source; and
a computing device coupled with the receiver for determining an optimal orientation of the main section based on the wind data and for directing the motors to drive the wheels of the mobile towers to orient the main section in the optimal orientation.

7. The irrigation system as set forth in claim 2, wherein the control system comprises:
a location-determining component for determining a current position or bearing of the main section;
a receiver for receiving wind data from a weather source; and
a computing device coupled with the receiver and the location-determining component for determining an optimal orientation of the main section based on the wind data and the current position or bearing of the main section and for directing the motors to drive the wheels of the mobile towers to orient the main section in the optimal orientation.

8. The irrigation system as set forth in claim 2, wherein the control system comprises:
a location-determining component for determining a current position or bearing of the main section;
a receiver for receiving wind speed and direction data from a weather source; and
a computing device coupled with the receiver and the location-determining component for determining an optimal orientation of the main section based on the wind speed and direction data and the current position or bearing of the main section and for directing the motors to drive the wheels of the mobile towers to orient the main section in the optimal orientation.

9. The irrigation system as set forth in claim 2, further comprising a main control system for controlling movement of the mobile towers and operation of the fluid-emitting devices in accordance with an irrigation control program.

10. The irrigation system as set forth in claim 9, wherein the control system is part of the main control system.

11. An irrigation system comprising:
a central pivot;
a main section pivotally connected to the central pivot, the main section comprising—
a series of mobile towers connected to the central pivot and to one another by support structure, each mobile tower having wheels and a motor for driving at least one of the wheels;
a water distribution conduit supported by the support structure;
a number of fluid-emitting devices connected to the water distribution conduit; and
a control system for positioning the main section relative to the central pivot to minimize wind damage.

12. The irrigation system as set forth in claim 11, wherein the control system comprises:
a location-determining component for determining a current position or bearing of the main section;
a wind sensor for determining wind direction; and
a computing device coupled with the wind sensor and the location-determining component for determining an optimal orientation of the main section based on the wind direction and the current position or bearing of the main section and for directing the motors to drive the wheels of the mobile towers to orient the main section in the optimal orientation.

13. The irrigation system as set forth in claim 11, wherein the control system comprises:
a location-determining component for determining a current position or bearing of the main section;
a receiver for receiving wind data from a weather source; and
a computing device coupled with the receiver and the location-determining component for determining an optimal orientation of the main section based on the wind data and the current position or bearing of the main section and for directing the motors to drive the wheels of the mobile towers to orient the main section in the optimal orientation.

14. An irrigation system comprising:
a plurality of mobile towers;
a water conduit supported by the towers; and
a control system for positioning the main section to minimize wind damage.

15. The irrigation system as set forth in claim 14, wherein the main section comprises:
a series of mobile towers connected to the central pivot and to one another by support structure, each mobile tower having wheels and a motor for driving at least one of the wheels;
a water distribution conduit supported by the support structure; and
a number of fluid-emitting devices connected to the water distribution conduit.

16. The irrigation system as set forth in claim 15, wherein the control system comprises:
a wind sensor for determining a wind direction; and
a computing device coupled with the wind sensor for determining an optimal orientation of the main section based on the wind direction and for directing the motors to drive the wheels of the mobile towers to orient the main section in the optimal orientation.

17. The irrigation system as set forth in claim 15, wherein the control system comprises:
a location-determining component for determining a current position or bearing of the main section;
a wind sensor for determining wind direction; and
a computing device coupled with the wind sensor and the location-determining component for determining an optimal orientation of the main section based on of the wind direction and the current position or bearing of the main section and for directing the motors to drive the wheels of the mobile towers to orient the main section in the optimal orientation.

18. The irrigation system as set forth in claim 15, wherein the control system comprises:
a location-determining component for determining a current position or bearing of the main section;
a wind sensor for determining wind direction and speed; and
a computing device coupled with the wind sensor and the location-determining component for determining an optimal orientation of the main section based on the wind speed, the wind direction, and the current position or bearing of the main section and for directing the motors to drive the wheels of the mobile towers to orient the main section in the optimal orientation.

19. The irrigation system as set forth in claim 15, wherein the control system comprises:
a receiver for receiving wind data from a weather source; and
a computing device coupled with the receiver for determining an optimal orientation of the main section based on the wind data and for directing the motors to drive the wheels of the mobile towers to orient the main section in the optimal orientation.

20. The irrigation system as set forth in claim 15, wherein the control system comprises:
a location-determining component for determining a current position or bearing of the main section;
a receiver for receiving wind data from a weather source; and
a computing device coupled with the receiver and the location-determining component for determining an optimal orientation of the main section based on the wind data and the current position or bearing of the main section and for directing the motors to drive the wheels of the mobile towers to orient the main section in the optimal orientation.
